(19) United States
(12) Patent Application Publication
(10) Pub. No.: US 2025/0045869 A1
(43) Pub. Date: Feb. 6, 2025

(54) METHOD, ELECTRONIC DEVICE, AND STORAGE MEDIUM FOR VIDEO-SPECIFIC SUPER-RESOLUTION

(71) Applicant: TENCENT TECHNOLOGY (SHENZHEN) COMPANY LIMITED, Shenzhen (CN)

(72) Inventors: Zirui WANG, Shenzhen (CN); Mingliang CHEN, Shenzhen (CN)

(21) Appl. No.: 18/922,568

(22) Filed: Oct. 22, 2024

Related U.S. Application Data
(63) Continuation of application No. PCT/CN2023/123916, filed on Oct. 11, 2023.

(30) Foreign Application Priority Data
Nov. 23, 2022 (CN) 202211476937.7

(51) Int. Cl. G06T 3/4053; G06T 1/60; G06T 7/20; G06V 10/44; G06V 10/80

(52) U.S. Cl. CPC G06T 3/4053; G06T 1/60; G06T 7/20; G06V 10/44; G06V 10/806

(57) ABSTRACT

A video-specific super-resolution method includes obtaining an (i+1)^{th} frame of image from a video, and obtaining image features of an i^{th} frame of image in the video and long time series features before the i^{th} frame of image, which are cached during super-resolution processing of the i^{th} frame of image; performing super-resolution prediction on the image features of the i^{th} frame of image, the long time series features before the i^{th} frame of image, and the (i+1)^{th} frame of image using a generative network, to obtain a super-resolution image of the (i+1)^{th} frame of image, image features of the (i+1)^{th} frame of image, and long time series features before the (i+1)^{th} frame of image; and caching the image features of the (i+1)^{th} frame of image and the long time series features before the (i+1)^{th} frame of image, i being a positive integer greater than 2.

### CROSS-REFERENCES TO RELATED APPLICATIONS

This application is a continuation application of PCT Patent Application No. PCT/CN2023/123916, filed on Oct. 11, 2023, which claims priority to Chinese Patent Application No. 202211476937.7, filed on Nov. 23, 2022, all of which is incorporated herein by reference in their entirety.

### FIELD OF THE TECHNOLOGY

The present disclosure relates to the field of artificial intelligence and, in particular, to method, computer device, and storage medium for video-specific super-resolution.

### BACKGROUND OF THE DISCLOSURE

With the development of image processing technologies, an image super-resolution processing technology has emerged for reconstructing an observed, low-resolution image (original image) into a corresponding high-resolution image to improve the resolution of the original image.

A generative network in a generative adversarial network is used to generate high-resolution images with richer details. However, because the generative adversarial network generates details randomly, same objects in adjacent frames are not completely aligned with each other after the super-resolution process, or details added to an (i+1)^{th} frame of image cannot be aligned with details added to an i^{th} frame of image. This results in visual perception of video discontinuity. In other words, an issue related to stability of time series continuity is prone to occur, for example, an inter-frame jump.

### SUMMARY

According to one embodiment of the present disclosure, a video-specific super-resolution method, performed by a computer device, is provided. The video-specific super-resolution method includes: obtaining an (i+1)^{th} frame of image from a video, and obtaining image features of an i^{th} frame of image in the video and long time series features before the i^{th} frame of image, the image features of the i^{th} frame of image and the long time series features before the i^{th} frame of image being cached during super-resolution processing of the i^{th} frame of image; performing super-resolution prediction on the image features of the i^{th} frame of image, the long time series features before the i^{th} frame of image, and the (i+1)^{th} frame of image using a generative network, to obtain a super-resolution image of the (i+1)^{th} frame of image, image features of the (i+1)^{th} frame of image, and long time series features before the (i+1)^{th} frame of image; and caching the image features of the (i+1)^{th} frame of image and the long time series features before the (i+1)^{th} frame of image, i being a positive integer greater than 2.

According to another embodiment of the present disclosure, a computer device is provided. The computer device includes one or more processors and a memory storing at least one instruction, at least one program, a code set, or an instruction set, that when the at least one instruction, the at least one program, the code set, or the instruction set being executed, cause the one or more processors to perform: obtaining an (i+1)^{th} frame of image from a video, and obtaining image features of an i^{th} frame of image in the video and long time series features before the i^{th} frame of image, the image features of the i^{th} frame of image and the long time series features before the i^{th} frame of image being cached during super-resolution processing of the i^{th} frame of image; performing super-resolution prediction on the image features of the i^{th} frame of image, the long time series features before the i^{th} frame of image, and the (i+1)^{th} frame of image using a generative network, to obtain a super-resolution image of the (i+1)^{th} frame of image, image features of the (i+1)^{th} frame of image, and long time series features before the (i+1)^{th} frame of image; and caching the image features of the (i+1)^{th} frame of image and the long time series features before the (i+1)^{th} frame of image, i being a positive integer greater than 2.

According to another embodiment of the present disclosure, a non-transitory computer-readable storage medium contains at least one program that, when being executed, causes at least one processor to perform: obtaining an (i+1)^{th} frame of image from a video, and obtaining image features of an i^{th} frame of image in the video and long time series features before the i^{th} frame of image, the image features of the i^{th} frame of image and the long time series features before the i^{th} frame of image being cached during super-resolution processing of the i^{th} frame of image; performing super-resolution prediction on the image features of the i^{th} frame of image, the long time series features before the i^{th} frame of image, and the (i+1)^{th} frame of image using a generative network, to obtain a super-resolution image of the (i+1)^{th} frame of image, image features of the (i+1)^{th} frame of image, and long time series features before the (i+1)^{th} frame of image; and caching the image features of the (i+1)^{th} frame of image and the long time series features before the (i+1)^{th} frame of image, i being a positive integer greater than 2.

### BRIEF DESCRIPTION OF THE DRAWINGS

To describe technical solutions of embodiments of the present disclosure more clearly, the following briefly describes accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a diagram of a structure of a video-specific super-resolution method according to an exemplary embodiment of the present disclosure.

FIG. 2 is a flowchart of a video-specific super-resolution method according to an exemplary embodiment of the present disclosure.

FIG. 3 is a flowchart of a video-specific super-resolution method according to an exemplary embodiment of the present disclosure.

FIG. 4 is a flowchart of a feature extraction network according to an exemplary embodiment of the present disclosure.

FIG. 5 is a flowchart of a feature fusion network according to an exemplary embodiment of the present disclosure.

FIG. 6 is a flowchart of a feature fusion network according to an exemplary embodiment of the present disclosure.

FIG. 7 is a flowchart of a video-specific super-resolution method according to an exemplary embodiment of the present disclosure.

FIG. 8 is a diagram of a structure of training in a video-specific super-resolution method according to an exemplary embodiment of the present disclosure.

FIG. 9 is a flowchart of training in a video-specific super-resolution method according to an exemplary embodiment of the present disclosure.

FIG. 10 is a flowchart of training in a video-specific super-resolution method according to an exemplary embodiment of the present disclosure.

FIG. 11 is a diagram of a structure of training in a video-specific super-resolution

method according to an exemplary embodiment of the present disclosure.

FIG. 12 is a block diagram of a video-specific super-resolution apparatus according to an exemplary embodiment of the present disclosure.

FIG. 13 is a block diagram of a video-specific super-resolution apparatus according to an exemplary embodiment of the present disclosure.

FIG. 14 is a block diagram of a computer device according to an exemplary embodiment of the present disclosure.

### DESCRIPTION OF EMBODIMENTS

To make objectives, technical solutions, and advantages of the present disclosure clearer, the following further describes implementations of the present disclosure in detail with reference to accompanying drawings.

First, terms used in embodiments of the present disclosure are briefly described.

Neural network: an algorithmic mathematical model that imitates behavioral characteristics of animal neural networks and performs distributed parallel information processing. This type of network depends on complexity of a system, and adjusts connection relationships between a lot of internal nodes, for achieving an objective of processing information.

Generative adversarial network (GAN): includes a generative network and a discriminative network. The generative network is configured to generate a super-resolution image, and the discriminative network is configured to determine whether an image conforms to distribution of a real image.

Image features: features for describing corresponding properties of an image or an image area, including a color feature, a texture feature, a shape feature, and a spatial relationship feature. Image features are extracted by a feature extraction layer in a neural network. Image features may be represented by using vectors.

Time series or time sequence: refers to a sequence of data points arranged in chronological order. As used herein, a time interval of a time series is a constant value, for example, 1 second or 1 minute or any suitable value. An image time series may be understood as 1 frame in one embodiment.

Resolution: may also refer to resolving power, and may include, for example, display resolution, image resolution, print resolution, scan resolution, and the like. A resolution determines fineness of image details. For example, a higher resolution of an image indicates a larger quantity of pixels included and a clearer image.

Although resolutions of displays gradually increase, it is difficult to reach 4K or 8K resolution when many videos are shot. A super-resolution technology can resolve the problem by increasing video resolutions to adapt to corresponding displays. At present, a super-resolution technology based on a deep neural network has a good effect in image processing. However, details and textures in a result of a neural network based on a pixel loss function are smooth, and a visual effect is poor. Compared with the neural network based on a pixel loss function, a generative adversarial network can generate a high-resolution image with more details and richer textures from each frame of image. However, because a generative adversarial network generates details randomly, applying a super-resolution technology based on a generative adversarial network to videos may result in a severe issue related to stability of time series continuity, for example, an inter-frame jump. An inter-frame jump means that the same object in adjacent frames is not completely aligned after super-resolution, or added details and textures are not aligned, appear in spurts, and drift leftward or rightward, leading to visual discontinuity and dissonance.

Various embodiments of the present disclosure provide method apparatus, electronic device, and storage medium for video-specific super-resolution. In one embodiment, time series features between different image frames may be introduced into the video super-resolution process and inter-frame jump problems are therefore solved.

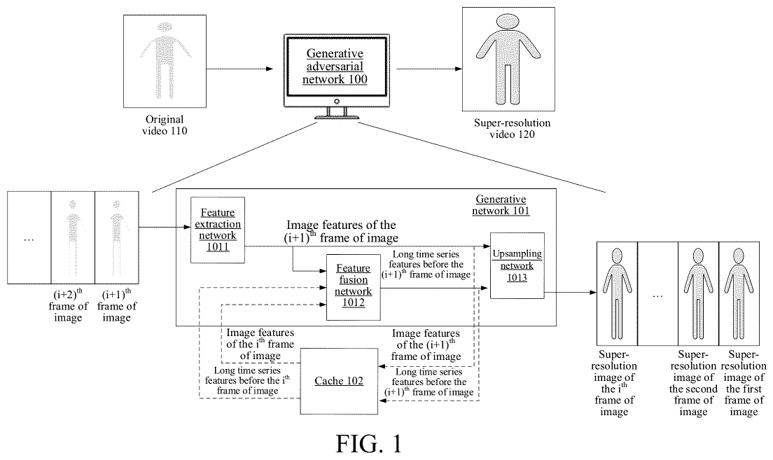

FIG. 1 is a diagram of a video-specific super-resolution method according to an exemplary embodiment of the present disclosure.

An original video 110 is inputted into a generative adversarial network 100, and a super-resolution video 120 corresponding to the original video 110 is outputted. The original video 110 has a first resolution, and the super-resolution video 120 has a second resolution. The first resolution is lower than the second resolution.

The original video 110 includes several frames of images. To perform super-resolution processing on the original video 110 is to perform super-resolution processing on the several frames of images in the original video 110, to obtain super-resolution images with a super resolution and then obtain the super-resolution video 120 that includes the super-resolution images. As shown in FIG. 1, the image frames in the original video 110 are inputted into the generative adversarial network 100 according to a time series of the video, to obtain a super-resolution image of the first frame of image, a super-resolution image of the second frame of image, . . . , and a super-resolution image of an i^{th} frame of image. A next to-be-inputted frame of image in the original video 110 is an (i+1)^{th} frame of image.

In some embodiments, the generative adversarial network 100 includes a generative network 101. The generative network 101 further includes a feature extraction network 1011, a feature fusion network 1012, and an upsampling network 1013. A low-resolution image (the (i+1)^{th} frame of image) in the original video 110 is inputted into the generative network 101, and image features of the (i+1)^{th} frame of image are obtained by using the feature extraction network 1011. The image features of the (i+1)^{th} frame of image, and image features of the i^{th} frame of image and long time series features before the i^{th} frame of image that are cached in a cache 102 are inputted into the feature fusion network 1012, to obtain long time series features before the (i+1)^{th} frame of image. The image features of the (i+1)^{th} frame of image and the long time series features before the (i+1)^{th} frame of image are inputted into the upsampling network 1013 for prediction, and a super-resolution image of the (i+1)^{th} frame of image is obtained.

The image features of the i^{th} frame of image and the long time series features before the i^{th} frame of image are cached in the cache 102 when the generative network 101 processes the i^{th} frame of image in the original video 110. When the generative network 101 processes the (i+1)^{th} frame of image in the original video 110, the cache 102 provides the image features of the i^{th} frame of image and the long time series features before the i^{th} frame of image to the feature fusion network 1012, and in addition, continues to cache the image features of the (i+1)^{th} frame of image and the long time series features before the (i+1)^{th} frame of image. This implements cyclic use of image features and long time series features.

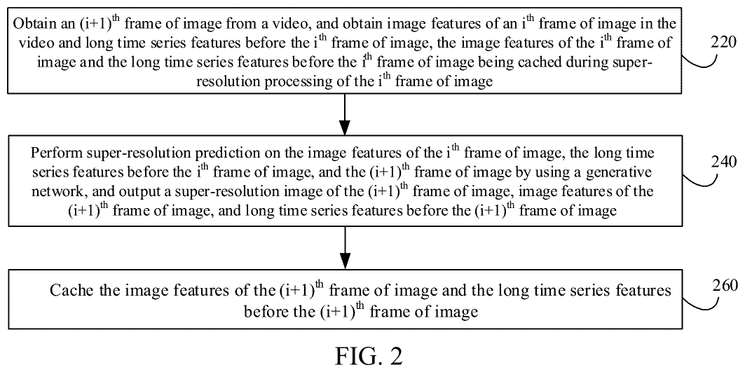

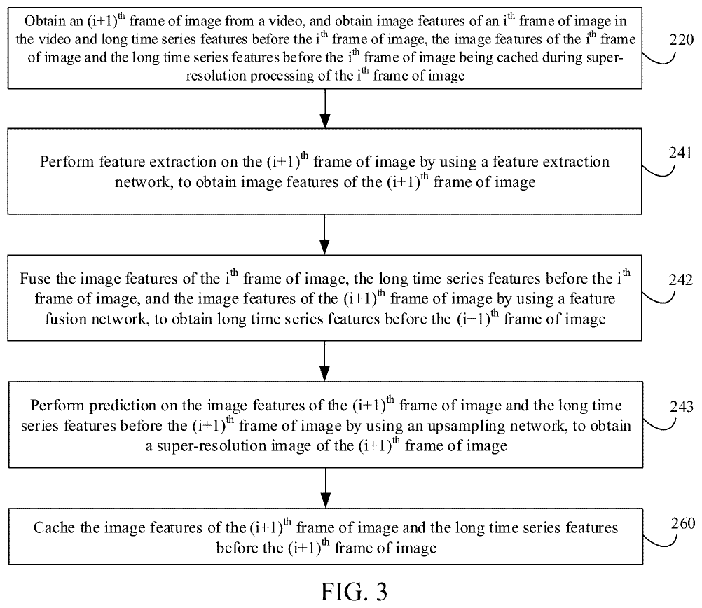

FIG. 2 is a flowchart of a video-specific super-resolution method according to an exemplary embodiment of the present disclosure. The method is performed by a computer device, and includes the following operations:

Operation 220: Obtain an (i+1)^{th} frame of image from a video, and obtain image features of an i^{th} frame of image in the video and long time series features before the i^{th} frame of image, the image features of the i^{th} frame of image and the long time series features before the i^{th} frame of image being cached during super-resolution processing of the i^{th} frame of image.

The (i+1)^{th} frame of image is obtained from the original video that needs to be processed. The (i+1)^{th} frame of image is an image frame that is in the original video and on which super-resolution processing needs to be performed currently, and is a low-resolution image frame. i is a positive integer greater than 2. In other words, long time series features may be generated, starting from the third frame of image. Thus, corresponding image features and long time series features are cached. Starting from the fourth frame of image, super-resolution processing may be performed by using the method provided in this embodiment.

When super-resolution operations are performed on the video, image frames in the video are sequentially processed according to a time series of the video. For example, the first frame of image is processed first, then the second frame of image is processed, . . . , and the i^{th} frame of image is processed. In a video super-resolution operation method, an i^{th} frame of image is directly inputted into a generative network, to obtain a super-resolution image of the i^{th} frame of image. With this method, when super-resolution prediction is performed on an image frame, information in the image frame is prone to be lost. Therefore, image features and long time series features are introduced in this embodiment of the present disclosure.

Long time series features are image features that are of a plurality of image frames and that are accumulated in a long time series according to an order in which super-resolution operations are performed on image frames in a video. Long time series features include information in several previous image frames in a super-resolution operation process. The long time series is a time series whose time length is greater than a threshold.

When super-resolution operations are performed on the first frame of image and the second frame of image in the original video, long time series features at this time may be considered as a null value or a preset value. This is not discussed in this embodiment.

In this embodiment, starting from the third frame of image in the original video, the long time series features before the image are generated when super-resolution processing is performed. Therefore, during super-resolution of the i^{th} frame of image, the image features of the i^{th} frame of image in the video and the long time series features before the i^{th} frame of image may be cached. The i^{th} frame of image is an image frame that is in the video and on which super-resolution processing has been performed.

In some embodiments, the long time series features before the i^{th} frame of image may be cumulative features of all images from the first frame of image to an (i−1)^{th} frame of image in the original video according to the play time series of the original video.

In some embodiments, the long time series features before the i^{th} frame of image may be cumulative features of last several frames of images before the i^{th} frame of image, for example, may be cumulative features of last three frames of images before the i^{th} frame of image, including image features of an (i−3)^{th} frame of image, image features of an (i−2)^{th} frame of image, and image features of the (i−1)^{th} frame of image; or may be cumulative features of last five frames of images before the i^{th} frame of image, including image features of an (i−5)^{th} frame of image, image features of an (i−4)^{th} frame of image, image features of an (i−3)^{th} frame of image, image features of an (i−2)^{th} frame of image, and image features of the (i−1)^{th} frame of image.

In some embodiments, the long time series features before the i^{th} frame of image may be determined based on a caching capability of a cache. If the caching capability of the cache is larger, more information about the long time series features before the i^{th} frame of image is retained. If the caching capability of the cache is smaller, less information about the long time series features before the i^{th} frame of image is retained.

Operation 240: Perform super-resolution prediction on the image features of the i^{th} frame of image, the long time series features before the i^{th} frame of image, and the (i+1)^{th} frame of image by using a generative network, and output a super-resolution image of the (i+1)^{th} frame of image, image features of the (i+1)^{th} frame of image, and long time series features before the (i+1)^{th} frame of image.

In some embodiments, the image features of the i^{th} frame of image and the long time series features before the i^{th} frame of image that are cached, and the (i+1)^{th} frame of image that is obtained from the video and on which super-resolution processing needs to be performed currently are inputted into the generative network for super-resolution prediction. The super-resolution image of the (i+1)^{th} frame of image, the image features of the (i+1)^{th} frame of image, and the long time series features before the (i+1)^{th} frame of image are outputted by the generative network.

Operation 260: Cache the image features of the (i+1)^{th} frame of image and the long time series features before the (i+1)^{th} frame of image.

After the image features of the (i+1)^{th} frame of image and the long time series features before the (i+1)^{th} frame of image are obtained, the image features of the (i+1)^{th} frame of image and the long time series features before the (i+1)^{th} frame of image may be cached, to be used for super-resolution processing of a next frame of image.

In conclusion, according to the method provided in this embodiment, after super-resolution processing is performed on the i^{th} frame of image, if i is a positive integer greater than 2, the image features of the i^{th} frame of image and the long time series features before the i^{th} frame of image can be generated. Therefore, the image features of the i^{th} frame of image and the long time series features before the i^{th} frame of image can be cached. The image features of the i^{th} frame of image can indicate information in a previous frame of image, and the long time series features before the i^{th} frame of image can indicate time series information between several previous frames of images. Therefore, when super-resolution processing is performed on the (i+1)^{th} frame of image in the video, to ensure time series stability between adjacent frames, the image features of the i^{th} frame of image and the long time series features before the i^{th} frame of image can be obtained. Thus, super-resolution prediction is performed on the image features of the i^{th} frame of image, the long time series features before the i^{th} frame of image, and the (i+1)^{th} frame of image by using the generative network. With reference to the current frame of image, the image features of the previous frame of image, and the long time series features before the previous frame of image, the super-resolution image of the (i+1)^{th} frame of image, the image features of the (i+1)^{th} frame of image, and the long time series features before the (i+1)^{th} frame of image are obtained. After that, the image features of the (i+1)^{th} frame of image and the long time series features before the (i+1)^{th} frame of image continue to be cached, to be used for super-resolution processing of a subsequent frame. Through caching of long time series features before previous frames, reference is made to the time series features before the previous frames of images when super-resolution is performed on the (i+1)^{th} frame of image. In other words, when super-resolution processing is performed to obtain details of the (i+1)^{th} frame of image, reference is made to details of the previous frames of images, for aligning details added to the (i+1)^{th} frame of image with details added to the i^{th} frame of image. In this way, time series stability between the adjacent frames can be ensured, so that no inter-frame jump occurs.

The generative network is configured to generate a super-resolution image of an image frame. As shown in FIG. 1, the generative network 101 includes the feature extraction network 1011, the feature fusion network 1012, and the upsampling network 1013. The (i+1)^{th} frame of image in the original video 110 is inputted into the generative network 101; the image features of the (i+1)^{th} frame of image are obtained by using the feature extraction network 1011 in the generative network 101; the image features of the i^{th} frame of image, the image features of the (i+1)^{th} frame of image, and the long time series features before the i^{th} frame of image are fused into the long time series features before the (i+1)^{th} frame of image by using the feature fusion network 1012 in the generative network; and the super-resolution image of the (i+1)^{th} frame of image is outputted through prediction performed by the upsampling network 1013 in the generative network 101.

In some embodiments, operation 240 further includes the following sub-operations:

Operation 241: Perform feature extraction on the (i+1)^{th} frame of image by using the feature extraction network, to obtain the image features of the (i+1)^{th} frame of image.

In some embodiments, the feature extraction network is configured to output the image features of the (i+1)^{th} frame of image based on an input of the (i+1)^{th} frame of image. By using the feature extraction network, an image corresponding to a low-resolution image frame in the original video is mapped to an eigenspace, and image features of the low-resolution image frame are extracted.

In one embodiment, a convolutional network may be used as the feature extraction network, and a plurality of convolution kernels of different sizes are used to process an image.

In some embodiments, the convolutional network includes a first convolution kernel, a second convolution kernel, a third convolution kernel, a fourth convolution kernel, and a fifth convolution kernel. The first convolution kernel, the second convolution kernel, and the fourth convolution kernel are 3*3 convolution kernels, and the third convolution kernel and the fifth convolution kernel are 1*1 convolution kernels. An original image is inputted into the first convolution kernel, the second convolution kernel, and the third convolution kernel. An output end of the first convolution kernel is connected to an input end of the fourth convolution kernel, and an output end of the second convolution kernel, an output end of the third convolution kernel, and an output end of the fourth convolution kernel are connected to an input end of the fifth convolution kernel. The fifth convolution kernel outputs image features of the original image.

The (i+1)^{th} frame of image is inputted into the convolutional network, and a first convolution result is obtained after convolution by the first convolution kernel.

A second convolution result is obtained after convolution by the second convolution kernel.

A third convolution result is obtained after convolution by the third convolution kernel.

The first convolution result is inputted into the fourth convolution kernel, and a fourth convolution result is obtained after convolution by the fourth convolution kernel.

The second convolution result, the third convolution result, and the fourth convolution result are inputted into the fifth convolution kernel, and the image features of the (i+1)^{th} frame of image are obtained after convolution by the fifth convolution kernel.

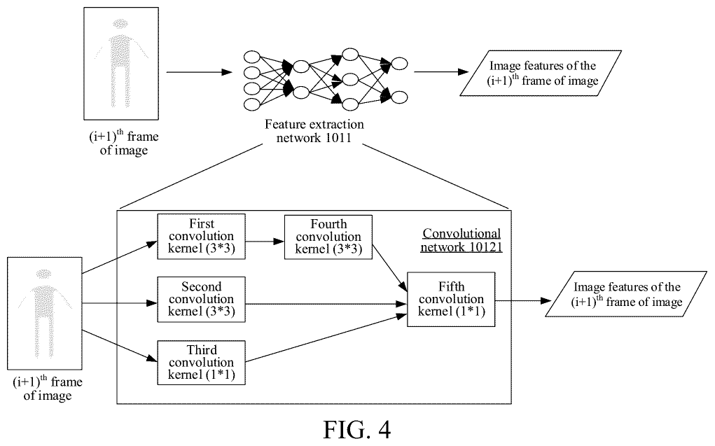

For example, as shown in FIG. 4, the (i+1)^{th} frame of image is inputted into the feature extraction network 1011, and the image features of the (i+1)^{th} frame of image can be outputted correspondingly. The (i+1)^{th} frame of image is inputted into the feature extraction network 1011. After the (i+1)^{th} frame of image moves through convolution kernels of different sizes, the image features of the (i+1)^{th} frame of image are outputted. A convolutional network 10121 is used as the feature extraction network 1011. The (i+1)^{th} frame of image is inputted into the feature extraction network 1011. After convolution by a first convolution kernel (3*3), a second convolution kernel (3*3), and a third convolution kernel (1*1) that are parallel, an output of the first convolution kernel (3*3) moves through a concatenated fourth convolution kernel (3*3), and an output of the second convolution kernel (3*3), an output of the third convolution kernel (1*1), and an output of the fourth convolution kernel (3*3) are inputted together into a fifth convolution kernel (1*1). The image features of the (i+1)^{th} frame of image are outputted.

In conclusion, according to the method provided in this embodiment, feature extraction is performed on an image by using the feature extraction network, to obtain image features of the corresponding image. The convolutional network is used and the plurality of convolution kernels of different sizes are used, to fully extract the image features and retain more information in the image, so that a super-resolution prediction result is more accurate.

Operation 242: Fuse the image features of the i^{th} frame of image, the long time series features before the i^{th} frame of image, and the image features of the (i+1)^{th} frame of image by using the feature fusion network, to obtain the long time series features before the (i+1)^{th} frame of image.

In some embodiments, the feature fusion network is configured to perform feature fusion on the image features of the i^{th} frame of image, the long time series features before the i^{th} frame of image, and the image features of the (i+1)^{th} frame of image, to output the long time series features before the (i+1)^{th} frame of image.

The feature fusion network is mainly configured to: align and extract features, concatenate features that need to be fused, cross-mix, by means of channel shuffle, at least two sets of features that need to be fused, and compress and extract cross-mixed features.

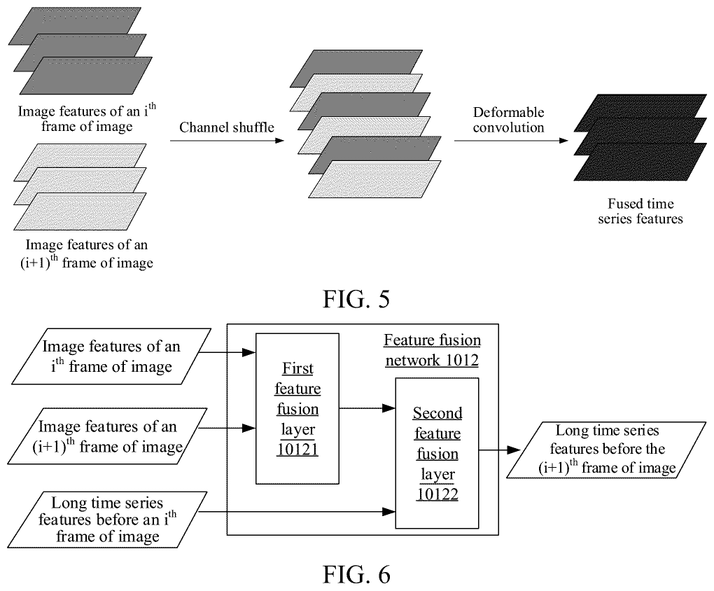

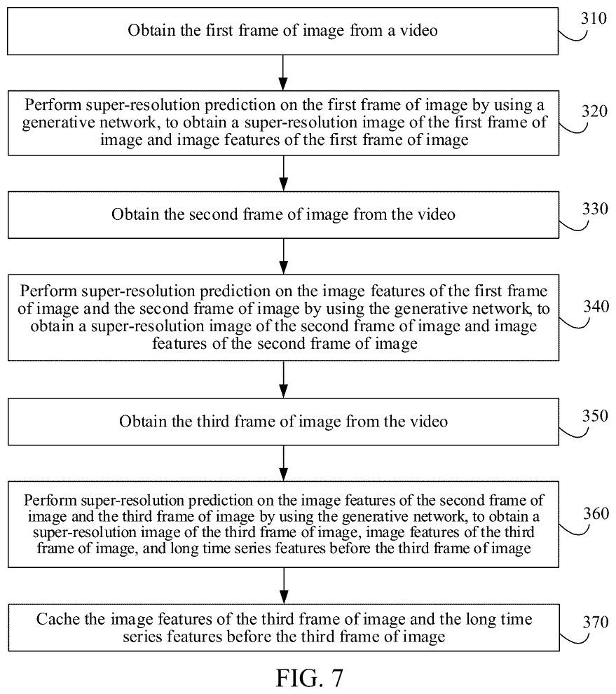

For example, as shown in FIG. 5, channel shuffle is performed on the image features of the (i+1)^{th} frame of image and the image features of the i^{th} frame of image to obtain mixed features, and the mixed features are compressed and extracted, for example, by means of a deformable convolutional network, to obtain fused time series features.

According to the method provided in this embodiment, image features are further fused by using the feature fusion network, to obtain long time series features. This increases a quantity of time series information during video image processing, so that information in previous image frames in a video time series can be fully utilized when a subsequent image is processed.

In some embodiments, the feature fusion network is a multi-phase fusion network, and includes at least a first feature fusion layer and a second feature fusion layer. The first feature fusion layer is configured to output the fused time series features based on an input of the image features of the (i+1)^{th} frame of image and the image features of the i^{th} frame of image. The second feature fusion layer is configured to output the long time series features before the (i+1)^{th} frame of image based on an input of the fused time series features obtained in the first phase and the long time series features before the i^{th} frame of image.

For example, as shown in FIG. 6, feature fusion is performed on the image features of the i^{th} frame of image, the long time series features before the i^{th} frame of image, and the image features of the (i+1)^{th} frame of image by using the feature fusion network 1012. The image features of the image frame on which super-resolution processing needs to be performed currently and the image features of the previous frame of image (the image features of the (i+1)^{th} frame of image and the image features of the i^{th} frame of image) are inputted into a first feature fusion layer 10121. Then, the long time series features before the previous frame of image (the long time series features before the i^{th} frame of image) and an output of the first feature fusion layer 10121 are inputted together into a second feature fusion layer 10122. The long time series features before the (i+1)^{th} frame of image are outputted.

According to the method provided in this embodiment, image features are further fused by using two phases of fusion layers. This can further prevent introduction of an artifact feature while improving an effect of feature fusion.

Operation 243: Perform prediction on the image features of the (i+1)^{th} frame of image and the long time series features before the (i+1)^{th} frame of image by using the upsampling network, to obtain the super-resolution image of the (i+1)^{th} frame of image.

In some embodiments, the upsampling network is configured to output the super-resolution image of the (i+1)^{th} frame of image based on an input of the image features of the (i+1)^{th} frame of image and the long time series features before the (i+1)^{th} frame of image.

Because super-resolution processing of the first frame of image and super-resolution processing of the second frame of image are slightly different from the foregoing operations, the present disclosure provides the following processing operations:

Operation 310: Obtain the first frame of image from the video.

The first frame of image is obtained from the original video.

Operation 320: Perform super-resolution prediction on the first frame of image by using the generative network, to obtain a super-resolution image of the first frame of image and image features of the first frame of image.

In some embodiments, only the first frame of image is inputted into the generative network. The image features of the first frame of image are obtained by using the feature extraction network in the generative network. The image features of the first frame of image are inputted into the upsampling network, to obtain the super-resolution image of the first frame of image. The image features of the first frame of image are cached in the cache for super-resolution prediction of a next frame of image.

In some embodiments, long time series features of image frames in the original video are preset. The first frame of image is inputted into the generative network. The image features of the first frame of image are obtained by using the feature extraction network in the generative network. The preset long time series features and the image features of the first frame of image are inputted into the feature fusion network, to obtain fused time series features. The image features of the first frame of image and the fused time series features are inputted into the upsampling network, to obtain the super-resolution image of the first frame of image. The image features of the first frame of image and the fused time series features are cached in the cache for super-resolution prediction of a next frame of image.

Operation 330: Obtain the second frame of image from the video.

The second frame of image is obtained from the original video.

Operation 340: Perform super-resolution prediction on the image features of the first frame of image and the second frame of image by using the generative network, to obtain a super-resolution image of the second frame of image and image features of the second frame of image.

In some embodiments, the second frame of image is inputted into the generative network. The image features of the second frame of image are obtained by using the feature extraction network in the generative network. The image features of the first frame of image that are cached in the cache and the image features of the second frame of image are inputted into the feature fusion network, to obtain fused features of the first frame of image and the second frame of image. The image features of the second frame of image and the fused features are inputted into the upsampling network, to obtain the super-resolution image of the second frame of image.

In some embodiments, the long time series features of the image frames in the original video are preset. The second frame of image is inputted into the generative network. The image features of the second frame of image are obtained by using the feature extraction network in the generative network. The image features of the second frame of image, and the image features of the first frame of image and the fused time series features that are cached in the cache are inputted into the feature fusion network, to obtain long time series features before the second frame of image. The image features of the second frame of image and the long time series features before the second frame of image are inputted into the upsampling network, to obtain the super-resolution image of the second frame of image.

Operation 350: Obtain the third frame of image from the video.

The third frame of image is obtained from the original video.

Operation 360: Perform super-resolution prediction on the image features of the second frame of image and the third frame of image by using the generative network, to obtain a super-resolution image of the third frame of image, image features of the third frame of image, and long time series features before the third frame of image.

In some embodiments, the third frame of image is inputted into the generative network. The image features of the third frame of image are obtained by using the feature extraction network in the generative network. The image features of the second frame of image that are cached in the cache and the image features of the third frame of image are inputted into the feature fusion network, to obtain fused features of the second frame of image and the third frame of image. The image features of the third frame of image and the fused features are inputted into the upsampling network, to obtain the super-resolution image of the third frame of image.

In some embodiments, the long time series features of the image frames in the original video are preset. The third frame of image is inputted into the generative network. The image features of the third frame of image are obtained by using the feature extraction network in the generative network. The image features of the third frame of image, and the image features of the second frame of image and the fused time series features that are cached in the cache are inputted into the feature fusion network, to obtain long time series features before the third frame of image. The image features of the third frame of image and the long time series features before the third frame of image are inputted into the upsampling network, to obtain the super-resolution image of the third frame of image.

Operation 370: Cache the image features of the third frame of image and the long time series features before the third frame of image.

Starting from the third frame of image in the original video, real long time series features may be generated. Therefore, the image features of the third frame of image and the long time series features before the third frame of image may be cached, to be used for super-resolution processing of a next frame of image. After that, the foregoing super-resolution prediction operation on the (i+1)^{th} frame of image may be performed.

A generative adversarial network includes a generative network and a discriminative network. The generative network is configured to generate a super-resolution image, and the discriminative network is configured to determine whether an image conforms to distribution of a real image. The discriminative network needs to be trained while the generative network is trained. The following embodiments mainly describe a method for training the generative network.

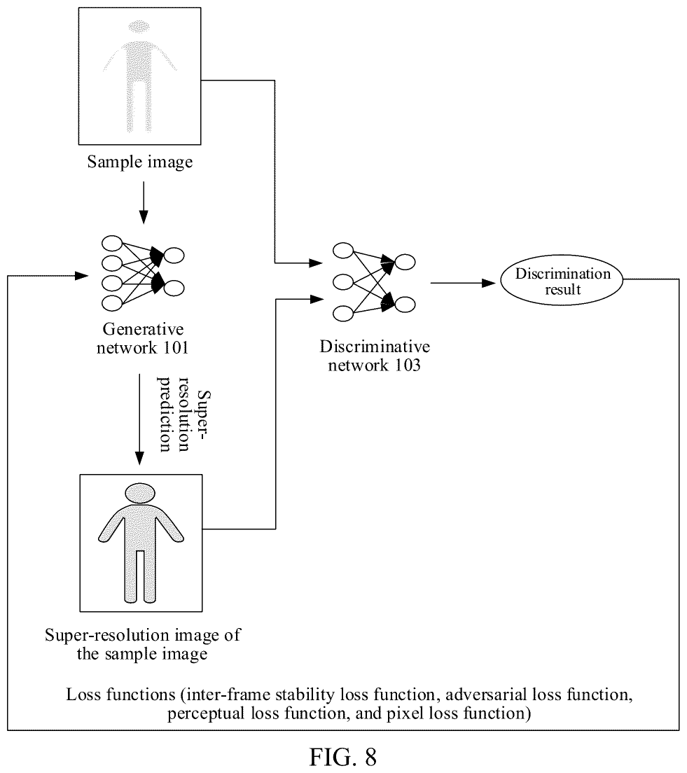

FIG. 8 is a diagram of a structure of training in a video-specific super-resolution method according to an exemplary embodiment of the present disclosure.

In some embodiments, the training in the video-specific super-resolution method is mainly training specific to a generative network 101. Whether a super-resolution image generated by the generative network 101 is accurate further needs to be determined by a discriminative network 103 to obtain a discrimination result. Therefore, the training in the video-specific super-resolution method further requires training of the discriminative network.

In some embodiments, a training process mainly includes: inputting a sample image into the generative network 101, to obtain a super-resolution image of the sample image through super-resolution prediction performed by the generative network 101; inputting the sample image and the super-resolution image of the sample image into the discriminative network 103 for discrimination, and outputting a discrimination result; and training the generative network and the discriminative network alternately based on the discrimination result and a loss function. The loss function includes at least one of an inter-frame stability loss function, an adversarial loss function, a perceptual loss function, and a pixel loss function.

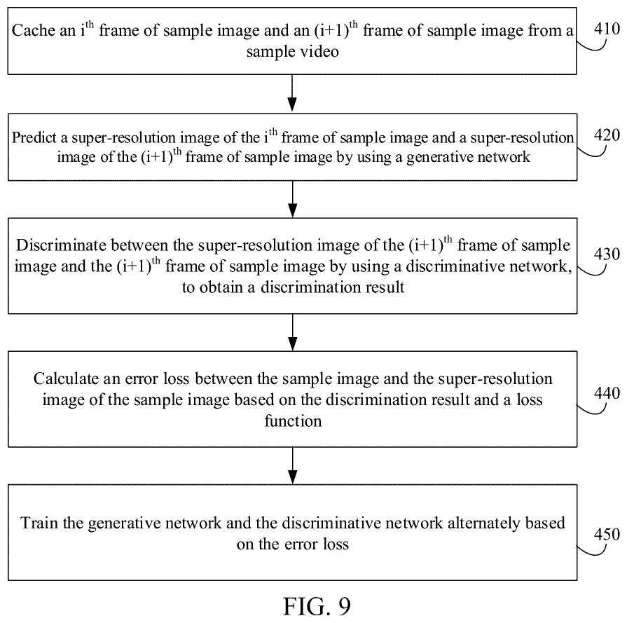

FIG. 9 is a flowchart of training in a video-specific super-resolution method according to an exemplary embodiment of the present disclosure. This method includes the following operations:

Operation 410: Cache an i^{th} frame of sample image and an (i+1)^{th} frame of sample image from a sample video.

In some embodiments, a training set is given for training a generative network, and the training set includes a sample video.

The i^{th} frame of sample image and the (i+1)^{th} frame of sample image are cached from the sample video. The (i+1)^{th} frame of sample image is a current image, and the i^{th} frame of sample image is a historical image in the sample video.

Operation 420: Predict a super-resolution image of the i^{th} frame of sample image and a super-resolution image of the (i+1)^{th} frame of sample image by using the generative network.

In some embodiments, the generative network is configured to perform super-resolution prediction on an image frame. An image frame on which super-resolution prediction needs to be performed is inputted to obtain a super-resolution image of the corresponding image frame. For example, the i^{th} frame of sample image and the (i+1)^{th} frame of sample image are inputted, and the super-resolution image of the i^{th} frame of sample image and the super-resolution image of the (i+1)^{th} frame of sample image are outputted through super-resolution prediction by the generative network.

Operation 430: Discriminate between the super-resolution image of the (i+1)^{th} frame of sample image and the (i+1)^{th} frame of sample image by using a discriminative network, to obtain a discrimination result.

In some embodiments, the generative network is configured to predict a super-resolution result of an image. The super-resolution result requires discrimination by the discriminative network. For example, the super-resolution image of the (i+1)^{th} frame of sample image generated by the generative network and the (i+1)^{th} frame of sample image are inputted into the discriminative network, and the discriminative network determines whether the super-resolution image is a real super-resolution image of the (i+1)^{th} frame of sample image or the super-resolution image of the (i+1)^{th} frame of sample image generated by the generative network. If the discrimination result outputted by a discriminator is true or 1, the super-resolution image of the (i+1)^{th} frame of sample image generated by the generative network conforms to distribution of the real super-resolution image of the (i+1)^{th} frame of sample image. If the discrimination result outputted by a discriminator is false or 0, the super-resolution image of the (i+1)^{th} frame of sample image generated by the generative network does not conform to distribution of the real super-resolution image of the (i+1)^{th} frame of sample image.

Operation 440: Calculate an error loss between the (i+1)^{th} frame of sample image and the super-resolution image of the (i+1)^{th} frame of sample image based on the discrimination result and a loss function.

Generally, part of a reason for an occurrence of an inter-frame jump may be that loss functions used in current super-resolution network training processes are mostly single-frame loss functions, which constrain a super-resolution result of each frame, and there is a lack of a constraint on stability between adjacent frames. This results in inconsistent results between the adjacent frames in output results, a noticeable jump, and poor stability. Based on this, in one embodiment, in addition to several loss functions commonly used in a generative adversarial network, for example, an adversarial loss function, the present disclosure further provides an inter-frame stability loss function, which is configured for constraining a change between adjacent image frames.

An inter-frame stability loss is a parameter that constrains stability of changes between adjacent image frames in a video. The inter-frame stability loss mainly compares a change between a super-resolution result of a current frame of sample image and a super-resolution result of a previous frame of sample image, and a change between the two corresponding sample images; and constrains the changes to be as close as possible or within a specific threshold.

The corresponding error loss is calculated based on at least one loss function and the result of discrimination that is between the sample image and the super-resolution image of the sample image and that is outputted by the discriminative network.

Operation 450: Train the generative network and the discriminative network alternately based on the error loss.

The error loss calculated based on the loss function is fed back to the generative network and the discriminative network, to train the generative network and the discriminative network alternately.

In some embodiments, training the generative network and the discriminative network alternately includes fixing parameters of the generative network and training the discriminative network; or fixing parameters of the discriminative network and training the generative network; or training the generative network and the discriminative network simultaneously.

To sum up, according to the method provided in this embodiment, the i^{th} frame of sample image and the (i+1)^{th} frame of sample image in the sample video are cached, the super-resolution images are predicted by using the generative network, discrimination is performed on the super-resolution result by using the discriminative network, and in addition, the generative network and the discriminative network are trained alternately with reference to the loss function. Using a pixel-level loss function for constraining adjacent frames can stably improve time series continuity of adjacent frames, for obtaining a generative network with more accurate generation results.

In some embodiments, after operation 430, training specific to the generative network and training specific to the discriminative network may be included.

Training specific to the generative network:

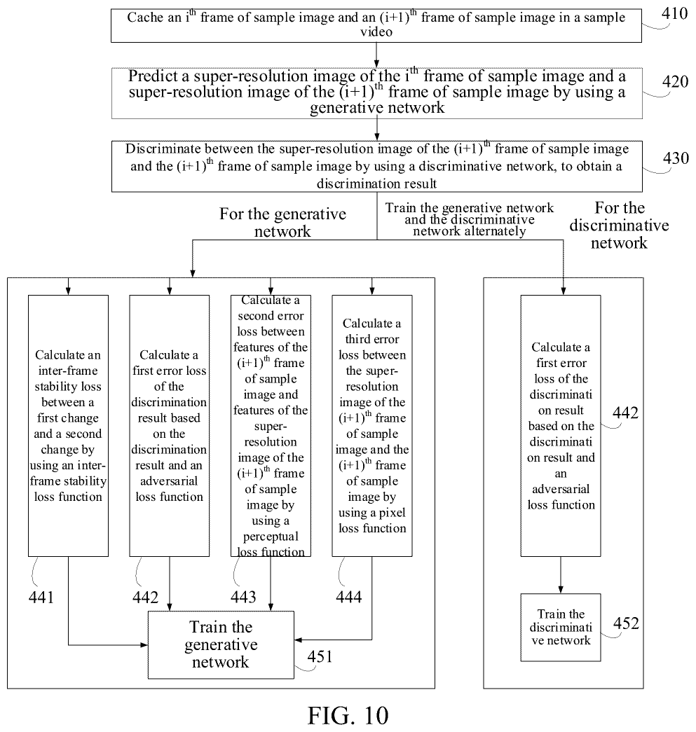

As shown in FIG. 10, operation 440 further includes the following sub-operations:

Operation 441: Calculate an inter-frame stability loss between a first change and a second change by using the inter-frame stability loss function.

Based on the i^{th} frame of sample image and the (i+1)^{th} frame of sample image, the generative network performs super-resolution prediction to obtain the super-resolution image of the i^{th} frame of sample image and the super-resolution image of the (i+1)^{th} frame of sample image. In this case, the first change is a change between the i^{th} frame of sample image and the (i+1)^{th} frame of sample image, and the second change is a change between the super-resolution image of the i^{th} frame of sample image and the super-resolution image of the (i+1)^{th} frame of sample image.

In this embodiment of the present disclosure, to resolve an inter-frame jump problem, a loss function used for the generative network during the training of the generative network may be the inter-frame stability loss function. Therefore, based on the inter-frame stability loss function, the inter-frame stability loss between the first change and the second change is calculated, that is, an inter-frame stability loss between: a stability loss of a change between adjacent frames of sample images and a stability loss of a change between super-resolution images of the adjacent frames of sample images, are calculated.

In conclusion, according to the method provided in this embodiment, the inter-frame stability loss is used to constrain the generative network, and using the loss function for constraining adjacent frames can stably improve time series continuity of adjacent frames.

In some embodiments, optical flows are used for measuring changes between adjacent image frames.

In some embodiments, a first optical flow between the i^{th} frame of sample image and the (i+1)^{th} frame of sample image is calculated by using an optical flow network, a second optical flow between the super-resolution image of the i^{th} frame of sample image and the super-resolution image of the (i+1)^{th} frame of sample image is calculated by using the optical flow network, and the inter-frame stability loss is calculated based on the first optical flow and the second optical flow.

In some embodiments, a mean square error loss, also referred to as an L2 norm loss, is used for calculating an average value of squared differences between actual values and predicted values. For example, D_{ifof}=Σᵢ₌₁^{N}(F(gᵢ₊₁, gᵢ)−F(GTᵢ₊₁, GTᵢ))², where i represents an i^{th} frame, N represents a maximum value of i, F( ) represents an optical flow, gᵢ represents an i^{th} frame of sample image, gᵢ₊₁ represents an (i+1)^{th} frame of sample image, F(gᵢ₊₁, gᵢ) represents a first optical flow between the i^{th} frame of sample image and the (i+1)^{th} frame of sample image, GTᵢ represents a super-resolution image of the i^{th} frame of sample image, GTᵢ₊₁ represents a super-resolution image of the (i+1)^{th} frame of sample image, and F(GTᵢ₊₁, GTᵢ) represents a second optical flow between the super-resolution image of the i^{th} frame of sample image and the super-resolution image of the (i+1)^{th} frame of sample image.

In some embodiments, a pre-trained optical flow network is used for calculating optical flows, and the optical flow network is not optimized in a training process. The inter-frame stability loss is calculated based on a mean square deviation between the first optical flow and the second optical flow.

In some embodiments, the inter-frame stability loss is used for constraining the changes between the adjacent frames of images. Training the generative network based on the inter-frame stability loss is mainly training the generative network based on the changes between the adjacent frames of images. The inter-frame stability loss is calculated based on a difference between the first optical flow and the second optical flow. The inter-frame stability loss is fed back to the generative network, to train the generative network.

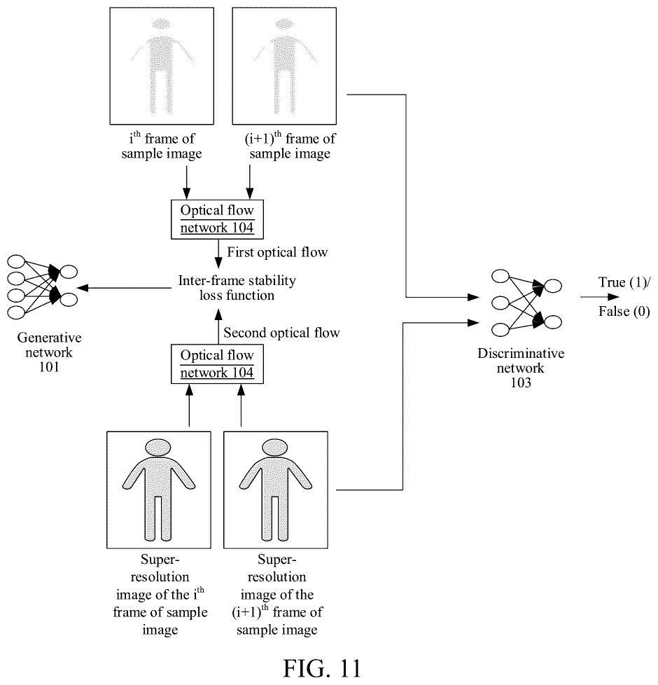

For example, as shown in FIG. 11, a discriminative network 103 performs result discrimination based on a sample image and a super-resolution image of the sample image, and outputs a true (1) result or a false (0) result. The i^{th} frame of sample image and the (i+1)^{th} frame of sample image are inputted into an optical flow network 104, to obtain the first optical flow. The super-resolution image of the i^{th} frame of sample image and the super-resolution image of the (i+1)^{th} frame of sample image are inputted into the optical flow network 104, to obtain the second optical flow. The first optical flow and the second optical flow are substituted into the inter-frame stability loss function, to calculate the inter-frame stability loss.

Operation 442: Calculate a first error loss of the discrimination result based on the discrimination result and an adversarial loss function.

The first error loss is an adversarial loss. The adversarial loss is a parameter configured for adjusting an output result of the generative network and an output result of the discriminative network, to make the output results tend to be consistent. Based on the adversarial loss function, the discriminative network may be trained in a process of training the generative network. Thus, the discriminative network can determine a difference between a generation result of the generative network and a real super-resolution image, and feed the difference back to the generative network, to cyclically train the generative network and the discriminative network.

In some embodiments, the generative network is trained by using the adversarial loss function. For example, D_{adv_G}=E_{x˜p(x)}[log(1−D(I_{g})], where D_{adv_G} represents a first error loss, E_{*} represents an expected value of the function, x is a low-resolution image, p(x) is distribution of the low-resolution image, D is a discriminative network, and I_{g} is a super-resolution result inputted into the discriminative network, the super-resolution result being generated by a generative network.

The first error loss between a super-resolution result predicted by the generative network and a real sample image is calculated by using the adversarial loss function, and the generative network is trained based on the discrimination result of the discriminative network, so that the super-resolution result predicted by the generative network is determined as the true (1) result by the discriminative network.

According to the method provided in this embodiment, optimization training of the generative network is further implemented by using the adversarial loss function, so that the generative network generates more real super-resolution results.

Operation 443: Calculate a second error loss between features of the (i+1)^{th} frame of sample image and features of the super-resolution image of the (i+1)^{th} frame of sample image by using a perceptual loss function.

The perceptual loss function constrains a super-resolution result and a sample result in terms of eigenspace. A sample image and a corresponding super-resolution image simultaneously move through a pre-trained convolutional neural network, such as a visual geometry group (VGG) network, and corresponding features are generated, respectively. A distance between the features of the sample image and the features of the corresponding super-resolution image is constrained.

In some embodiments, the second error loss between the features of the (i+1)^{th} frame of sample image and the features of the super-resolution image of the (i+1)^{th} frame of sample image is calculated by using the perceptual loss function. The generative network is trained based on the second error loss between the features of the (i+1)^{th} frame of sample image and the features of the super-resolution image of the (i+1)^{th} frame of sample image.

In some embodiments, a mean square error loss function is used as the perceptual loss function to calculate an average value of squared differences between image features of real sample images and image features of predicted super-resolution images, to train the generative network. For example, D_{perc}=Σᵢ₌₀^{N}(VGG(gᵢ₊₁)−VGG(GTᵢ₊₁))², where D_{perc} represents a second error loss, i represents an i^{th} frame, N represents a maximum value of i, gᵢ₊₁ is a super-resolution image of an (i+1)^{th} frame of sample image, GTᵢ₊₁ is the (i+1)^{th} frame of sample image, VGG(gᵢ₊₁) is image features of the super-resolution image of the (i+1)^{th} frame of sample image, and VGG(GTᵢ₊₁) is image features of the (i+1)^{th} frame of sample image.

According to the method provided in this embodiment, a sample image and a super-resolution image are further constrained in terms of eigenspace by using the perceptual loss function. In this way, a quantity of reference information of an image is larger, and an effect of training is better.

Operation 444: Calculate a third error loss between the super-resolution image of the (i+1)^{th} frame of sample image and the (i+1)^{th} frame of sample image by using a pixel loss function.

The third error loss is a pixel loss. The pixel loss is a parameter configured for supervising that a super-resolution image predicted by the generative network does not deviate from an original low-resolution image. A large difference between a super-resolution result and a sample image is prevented based on a pixel loss function.

In some embodiments, an error loss between the super-resolution image of the (i+1)^{th} frame of sample image and the (i+1)^{th} frame of sample image is calculated by using the pixel loss function. The generative network is trained based on the error loss between the super-resolution image of the (i+1)^{th} frame of sample image and the (i+1)^{th} frame of sample image.

In some embodiments, a mean square error loss function is used as the pixel loss function to calculate an average value of squared differences between the real sample images and the predicted super-resolution images of the sample images, to train the generative network. For example, Dₚᵢₓₑₗ=Σᵢ₌₀^{N}(gᵢ₊₁−GTᵢ₊₁)², where i represents an i^{th} frame, N represents a maximum value of i, gᵢ₊₁ is a super-resolution image of an (i+1)^{th} frame of sample image, and GTᵢ₊₁ is the (i+1)^{th} frame of sample image.

According to the method provided in this embodiment, a difference between a sample image and a super-resolution image is constrained within a specific range by using the pixel loss function, so that the training process is stabler.

Operation 450 further includes the following sub-operations:

Operation 451: Train the generative network.

The generative network is trained based on the at least one of the inter-frame stability loss function, the adversarial loss function, the perceptual loss function, and the pixel loss function, so that a super-resolution image that is of a sample image and that is predicted by the generative network is close to the sample image.

In some embodiments, only the inter-frame stability loss function may be used to train the generative network, and other loss functions are not used.

In some embodiments, only the adversarial loss function may be used to train the generative network, and other loss functions are not used.

In some embodiments, only the perceptual loss function may be used to train the generative network, and other loss functions are not used.

In some embodiments, only the pixel loss function may be used to train the generative network, and other loss functions are not used.

In some embodiments, the inter-frame stability loss function and the adversarial loss function may be used to train the generative network, and other loss functions are not used.

In some embodiments, the inter-frame stability loss function and the perceptual loss function may be used to train the generative network, and other loss functions are not used.

In some embodiments, the inter-frame stability loss function and the pixel loss function may be used to train the generative network, and other loss functions are not used.

In some embodiments, the inter-frame stability loss function, the adversarial loss function, and the perceptual loss function may be used to train the generative network, and other loss functions are not used.

In some embodiments, the inter-frame stability loss function, the adversarial loss function, and the pixel loss function may be used to train the generative network, and other loss functions are not used.

In some embodiments, the inter-frame stability loss function, the perceptual loss function, and the pixel loss function may be used to train the generative network, and other loss functions are not used.

In some embodiments, the inter-frame stability loss function, the adversarial loss function, the perceptual loss function, and the pixel loss function may all be used to train the generative network.

Training specific to the discriminative network:

Operation 442: Calculate a first error loss of the discrimination result based on the discrimination result and an adversarial loss function.

The discrimination result is obtained by using the discriminative network to discriminate between the super-resolution image of the (i+1)^{th} frame of sample image and the (i+1)^{th} frame of sample image. An adversarial loss is a parameter configured for adjusting an output result of the generative network and an output result of the discriminative network, to make the output results tend to be consistent. Based on the adversarial loss function, the discriminative network may be trained in a process of training the generative network. Thus, the discriminative network can determine a difference between a generation result of the generative network and a real super-resolution image, and feed the difference back to the generative network, to cyclically train the generative network and the discriminative network.

In some embodiments, the discriminative network is trained by using the adversarial loss function. For example, D_{adv_D}=−E_{x˜p(x)}[log(1−D(I_{g})]+E_{xr˜p(xr)}[log D(xr)], where x is a low-resolution image, p(x) is distribution of the low-resolution image, xr is a super-resolution image, p(xr) is distribution of the super-resolution image, D is a discriminative network, and I_{g} is a super-resolution result inputted into the discriminative network, the super-resolution result being generated by a generative network.

Operation 450 further includes the following sub-operations:

Operation 452: Train the discriminative network.

The discriminative network is trained based on the adversarial loss function, so that the

discriminative network can determine a difference between a super-resolution result predicted by the generative network and an accurate super-resolution result, to train the discriminator for accuracy of a discriminant result.

The present disclosure provides the video-specific super-resolution method that ensures stability of feature time series based on a constraint on adjacent frames. The generative adversarial network is used as an entire network to generate a super-resolution image with rich details and textures. The generative network uses a cyclic structure to add information transfer between adjacent frames in a video, and uses inter-frame information to improve a super-resolution effect and stability. In terms of loss functions, a the adversarial loss function is used to increase textures and details, and in addition, the image-level pixel loss function and the perceptual loss function are used to ensure that a super-resolution result of a single frame does not significantly deviate from an original image. Moreover, the present disclosure further provides an inter-frame stability loss function to perform inter-frame constraint on adjacent super-resolution results. This improves stability between video frames and reduces jumps, ensuring visual perception of video continuity and consistency.

The present disclosure mainly provides two innovation points:
1. A feature circulation network is used as the generative network, and features instead of an image are used as an input for a time series. Advantages thereof are as follows:
   Efficiency is higher. Features may be directly used as an input for a next frame without a need for mapping to the eigenspace through a network. This can reduce a time cost. A longer time series indicates a greater time advantage over an image input.
   More information is retained in features as compared with an image. In addition, features of a previous frame and long time series features are introduced. Through an increase in a quantity of time series information, problems caused by an image input, such as an information loss and an information error, are alleviated. Examples of an information error include bending, an artifact, and the like.
2. The constraint on adjacent frames is added to the training process. Advantages thereof are as follows:
   Using the pixel-level loss function for constraining adjacent frames can stably improve time series continuity of adjacent frames.
   Only the constraint on adjacent frames needs to be added to video forward sequence training, so that stability of inter-frame super-resolution results can be constrained and texture jumps in an output result can be reduced. Reverse sequence training is not required.

The technical process of the present disclosure mainly includes two parts: the generative network and the training of the generative network. The generative network is a network that generates a super-resolution result, and is also used during actual application. The training of the generative network includes the discriminative network, the VGG network, the optical flow network, and the loss functions. A main role is to supervise the super-resolution result in the training process, to constrain the generative network.

An input to the generative network includes a current frame of image, features of a previous frame, and long time series features before the previous frame. After the input moves through a structure of the generative network, features of the current frame, long time series features before the current frame, and a super-resolution image of the current frame are outputted. Both the features of the current frame and the long time series features before the current frame are used as an input to the generative network for a subsequent image. The super-resolution image enters a training phase, and is also outputted directly during application. The inputted image first moves through the feature extraction network, and the image is mapped to the eigenspace; then, extracted features together with the features of the previous frame and the long time series features before the previous frame are inputted into the feature fusion network for fusion; and after fused features move through the upsampling network, the super-resolution result is obtained. The extracted features and the fused features in the generation phase are respectively used in super-resolution of a next frame and a next frame of the next frame as inputs, to provide supplementary information.

A role of the feature extraction network is to map the inputted image to the eigenspace. An input is the image, and an output is the extracted features. The features are inputted into the super-resolution process of the next frame as an input. The feature extraction network used in the present disclosure is a convolutional network. To fully extract image features, convolutions with different receptive fields are used to process an input.

In the present disclosure, the multi-phase feature fusion network is used as the feature fusion network to fuse the features of the current frame, the features of the previous frame, and the long time series features before the previous frame. First, the features of the current frame and the features of the previous frame are fused, and then fused features of the two frames are fused with the long time series features before the previous frame. A deformable convolution is mainly used to align and extract features. Two sets of features are concatenated, then the features are cross-mixed through a channel shuffle operation, and then mixed features are compressed and extracted by means of the deformable convolution.

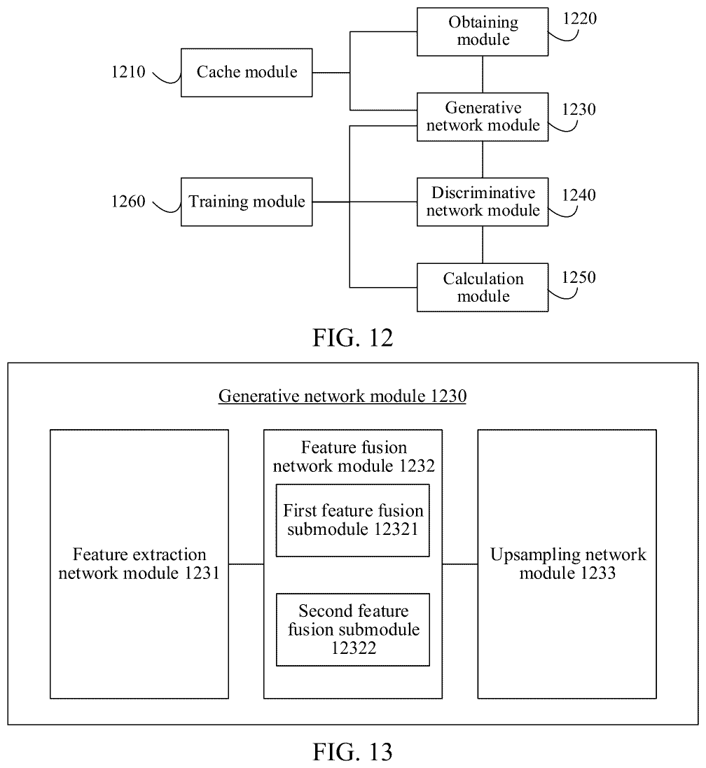

FIG. 12 is a block diagram of a video-specific super-resolution apparatus according to an exemplary embodiment of the present disclosure. The apparatus includes:
an obtaining module 1220, configured to: obtain an (i+1)^{th} frame of image from a video, and obtain image features of an i^{th} frame of image in the video and long time series features before the i^{th} frame of image, the image features of the i^{th} frame of image and the long time series features before the i^{th} frame of image being cached by a cache module 1210 during super-resolution processing of the i^{th} frame of image;
a generative network module 1230, configured to perform super-resolution prediction on the image features of the i^{th} frame of image, the long time series features before the i^{th} frame of image, and the (i+1)^{th} frame of image, to obtain a super-resolution image of the (i+1)^{th} frame of image, image features of the (i+1)^{th} frame of image, and long time series features before the (i+1)^{th} frame of image; and
the cache module 1210, configured to cache the image features of the (i+1)^{th} frame of image and the long time series features before the (i+1)^{th} frame of image;
i being a positive integer greater than 2.

In one embodiment, as shown in FIG. 13, the generative network module 1230 includes a feature extraction network module 1231, a feature fusion network module 1232, and an upsampling network module 1233.

The feature extraction network module 1231 is configured to perform feature extraction on the (i+1)^{th} frame of image, to obtain the image features of the (i+1)^{th} frame of image.

The feature fusion network module 1232 is configured to fuse the image features of the i^{th} frame of image, the long time series features before the i^{th} frame of image, and the image features of the (i+1)^{th} frame of image, to obtain the long time series features before the (i+1)^{th} frame of image.

The upsampling network module 1233 is configured to perform prediction on the image features of the (i+1)^{th} frame of image and the long time series features before the (i+1)^{th} frame of image, to obtain the super-resolution image of the (i+1)^{th} frame of image.

In one embodiment, the feature fusion network module 1232 includes a first feature fusion sub-module 12321 and a second feature fusion sub-module 12322.

The first feature fusion sub-module 12321 is configured to fuse the image features of the (i+1)^{th} frame of image and the image features of the i^{th} frame of image, to obtain fused time series features.

The second feature fusion sub-module 12322 is configured to fuse the fused time series features and the long time series features before the i^{th} frame of image, to obtain the long time series features before the (i+1)^{th} frame of image.

In one embodiment, the obtaining module 1220 is further configured to obtain the first frame of image from the video.

The generative network module 1230 is further configured to perform super-resolution prediction on the first frame of image, to obtain a super-resolution image of the first frame of image and image features of the first frame of image.

The obtaining module 1220 is further configured to obtain the second frame of image from the video.

The generative network module 1230 is further configured to perform super-resolution prediction on the image features of the first frame of image and the second frame of image, to obtain a super-resolution image of the second frame of image and image features of the second frame of image.

The obtaining module 1220 is further configured to obtain the third frame of image from the video.

The generative network module 1230 is further configured to perform super-resolution prediction on the image features of the second frame of image and the third frame of image, to obtain a super-resolution image of the third frame of image, image features of the third frame of image, and long time series features before the third frame of image.

The cache module 1210 is configured to cache the image features of the third frame of image and the long time series features before the third frame of image.

In one embodiment, the generative network module 1230 is obtained through training in the following mode:

The caching module 1210 is further configured to cache an i^{th} frame of sample image and an (i+1)^{th} frame of sample image from a sample video.

The generative network module 1230 is configured to predict a super-resolution image of the i^{th} frame of sample image and a super-resolution image of the (i+1)^{th} frame of sample image.

A calculation module 1250 is configured to calculate an inter-frame stability loss between a first change and a second change by using an inter-frame stability loss function. The first change is a change between the i^{th} frame of sample image and the (i+1)^{th} frame of sample image, and the second change is a change between the super-resolution image of the i^{th} frame of sample image and the super-resolution image of the (i+1)^{th} frame of sample image. The inter-frame stability loss is configured for constraining stability between adjacent frames of images.

A training module 1260 is configured to train the generative network module based on the inter-frame stability loss.

In one embodiment, the calculation module 1250 is further configured to calculate a first optical flow of the first change by using an optical flow network module.

The calculation module 1250 is further configured to calculate a second optical flow of the second change by using the optical flow network module.

The calculation module 1250 is further configured to substitute the first optical flow and the second optical flow into the inter-frame stability loss function, to calculate the inter-frame stability loss.

In one embodiment, a discriminative network module 1240 is configured to discriminate between the super-resolution image of the (i+1)^{th} frame of sample image and the (i+1)^{th} frame of sample image, to obtain a discrimination result.

The calculation module 1250 is further configured to calculate a first error loss of the discrimination result based on the discrimination result and an adversarial loss function.

The training module 1260 is further configured to train the generative network and the discriminative network alternately based on the first error loss.

The adversarial loss function is configured for constraining consistency between a super-resolution result of the (i+1)^{th} frame of sample image and the discrimination result.

In one embodiment, the calculation module 1250 is further configured to calculate a second error loss between features of the (i+1)^{th} frame of sample image and features of the super-resolution image of the (i+1)^{th} frame of sample image by using a perceptual loss function.

The training module 1260 is further configured to train the generative network based on the second error loss.

The perceptual loss function is configured for constraining consistency between the (i+1)^{th} frame of sample image and the super-resolution image of the (i+1)^{th} frame of sample image in terms of eigenspace.

In one embodiment, the calculation module 1250 is further configured to calculate a third error loss between the super-resolution image of the (i+1)^{th} frame of sample image and the (i+1)^{th} frame of sample image by using a pixel loss function.

The training module 1260 is further configured to train the generative network based on the third error loss.

The pixel loss function is configured for constraining consistency between the super-resolution image of the (i+1)^{th} frame of sample image and the (i+1)^{th} frame of sample image in terms of image content.

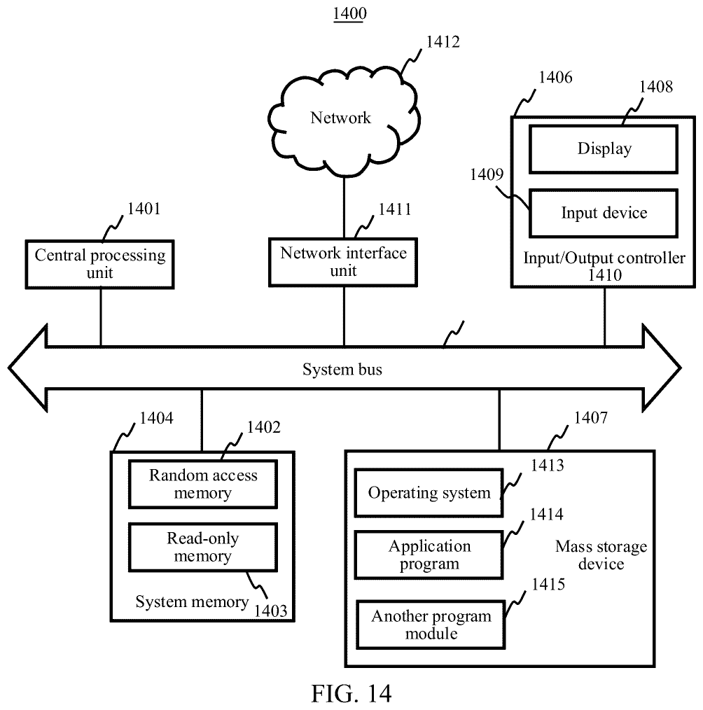

FIG. 14 is a diagram of a structure of a computer device according to an exemplary embodiment of the present disclosure. For example, a computer device 1400 includes a central processing unit (CPU) 1401, a system memory 1404 including a random access memory (RAM) 1402 and a read-only memory (ROM) 1403, and a system bus 1405 connecting the system memory 1404 and the central processing unit 1401. The computer device 1400 further includes a basic input/output (I/O) system 1406 assisting in transmitting information between components in the computer, and a mass storage device 1407 configured to store an operating system 1413, a client 1414, and another program module 1415.

The basic I/O system 1406 includes a display 1408 configured to display information, and an input device 1409 configured for inputting information by a user, such as a mouse or a keyboard. The display 1408 and the input device 1409 are both connected to the central processing unit 1401 by using an input/output controller 1410 connected to the system bus 1405. The basic I/O system 1406 may further include the input/output controller 1410 configured to receive and process inputs from a plurality of other devices such as a keyboard, a mouse, and an electronic stylus. Likewise, the input/output controller 1410 further provides an output to a display screen, a printer, or another type of output device.

The mass storage device 1407 is connected to the central processing unit 1401 by using a mass storage controller (not shown) connected to the system bus 1405. The mass storage device 1407 and a computer-readable medium associated with the mass storage device 1407 provide non-volatile storage for the computer device 1400. To be specific, the mass storage device 1407 may include a computer-readable medium (not shown) such as a hard disk or a compact disc read-only memory (CD-ROM) drive.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The computer-readable medium may include a computer storage medium and a communication medium. The computer storage medium includes a volatile or non-volatile, or removable or non-removable medium that is implemented by using any method or technology and that is configured for storing information such as a computer-readable instruction, a data structure, a program module, or other data. The computer storage medium includes a RAM, a ROM, an erasable programmable read-only memory (EPROM), an electrically erasable programmable read-only memory (EEPROM), a flash memory or another solid-state memory technology, a CD-ROM, a digital versatile disc (DVD) or another optical memory, a tape cartridge, a magnetic tape, a magnetic disk memory, or another magnetic storage device. Certainly, a person skilled in the art may learn that the computer storage medium is not limited to the foregoing several types. The system memory 1404 and the mass storage device 1407 may be collectively referred to as a memory.

According to the embodiments of the present disclosure, the computer device 1400 may further be connected, through a network such as the Internet, to a remote computer on the network and run. To be specific, the computer device 1400 may be connected to a network 1412 by using a network interface unit 1411 connected to the system bus 1405, or may be connected to another type of network or a remote computer system (not shown) by using a network interface unit 1411.

An exemplary embodiment of the present disclosure further provides a computer-readable storage medium. The computer-readable storage medium stores at least one program. The at least one program is loaded and executed by a processor to implement the video-specific super-resolution method according to the foregoing method embodiments.

An exemplary embodiment of the present disclosure further provides a computer program product. The computer program product includes at least one program, and the at least one program is stored in a computer readable storage medium. At least one processor of a computer device reads the at least one program from the computer readable storage medium, and the at least one processor executes the at least one program to cause the computer device to perform the video-specific super-resolution method according to the foregoing method embodiments.

As such, after super-resolution processing is performed on the i^{th} frame of image, if i is a positive integer greater than 2, the image features of the i^{th} frame of image and the long time series features before the i^{th} frame of image can be generated after super-resolution processing is performed on the i^{th} frame of image. Therefore, the image features of the i^{th} frame of image and the long time series features before the i^{th} frame of image can be cached. The image features of the i^{th} frame of image can indicate information in a previous frame of image, and the long time series features before the i^{th} frame of image can indicate time series information between several previous frames of images. Therefore, when super-resolution processing is performed on the (i+1)^{th} frame of image in the video, to ensure time series stability between adjacent frames, the image features of the i^{th} frame of image and the long time series features before the i^{th} frame of image can be obtained. Thus, super-resolution prediction is performed on the image features of the i^{th} frame of image, the long time series features before the i^{th} frame of image, and the (i+1)^{th} frame of image by using the generative network. With reference to the current frame of image, the image features of the previous frame of image, and the long time series features before the previous frame of image, the super-resolution image of the (i+1)^{th} frame of image, the image features of the (i+1)^{th} frame of image, and the long time series features before the (i+1)^{th} frame of image are obtained. After that, the image features of the (i+1)^{th} frame of image and the long time series features before the (i+1)^{th} frame of image continue to be cached, to be used for super-resolution processing of a subsequent frame. Through caching of long time series features before previous frames, reference is made to the time series features before the previous frames of images when super-resolution is performed on the (i+1)^{th} frame of image. In other words, when super-resolution processing is performed to obtain details of the (i+1)^{th} frame of image, reference is made to details of the previous frames of images, to align details added to the (i+1)^{th} frame of image with details added to the i^{th} frame of image. In this way, time series stability between the adjacent frames can be ensured, so that no inter-frame jump occurs.

“A plurality of” mentioned in the specification means two or more. After considering the specification and practicing the present disclosure, a person skilled in the art may easily conceive of other implementations of the present disclosure. The present disclosure is intended to cover any variations, uses, or adaptive changes of the present disclosure. These variations, uses, or adaptive changes follow the general principles of the present disclosure and include common general knowledge or common technical means in the art, which are not disclosed in the present disclosure. The specification and embodiments are considered as merely exemplary, and the actual scope and spirit of the present disclosure are pointed out in the following claims.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely optional embodiments of the present disclosure, but are not intended to limit the present disclosure. Any modification, equivalent replacement, improvement, or the like made within the spirit and principle of the present disclosure shall fall within the protection scope of the present disclosure.

What is claimed is:

1. A video-specific super-resolution method, performed by a computer device, and comprising:
obtaining an (i+1)^{th} frame of image from a video, and obtaining image features of an i^{th} frame of image in the video and long time series features before the i^{th} frame of image, the image features of the i^{th} frame of image and the long time series features before the i^{th} frame of image being cached during super-resolution processing of the i^{th} frame of image;
performing super-resolution prediction on the image features of the i^{th} frame of image, the long time series features before the i^{th} frame of image, and the (i+1)^{th} frame of image using a generative network, to obtain a super-resolution image of the (i+1)^{th} frame of image, image features of the (i+1)^{th} frame of image, and long time series features before the (i+1)^{th} frame of image; and
caching the image features of the (i+1)^{th} frame of image and the long time series features before the (i+1)^{th} frame of image;
i being a positive integer greater than 2.

2. The method according to claim 1, wherein the generative network comprises a feature extraction network, a feature fusion network, and an upsampling network; and performing the super-resolution prediction on the image features of the i^{th} frame of image, the long time series features before the i^{th} frame of image, and the (i+1)^{th} frame of image by using a generative network comprises:
performing feature extraction on the (i+1)^{th} frame of image using the feature extraction network, to obtain the image features of the (i+1)^{th} frame of image;
fusing the image features of the i^{th} frame of image, the long time series features before the i^{th} frame of image, and the image features of the (i+1)^{th} frame of image using the feature fusion network, to obtain the long time series features before the (i+1)^{th} frame of image; and
performing prediction on the image features of the (i+1)^{th} frame of image and the long time series features before the (i+1)^{th} frame of image by using the upsampling network, to obtain the super-resolution image of the (i+1)^{th} frame of image.

3. The method according to claim 2, wherein the feature fusion network comprises a first feature fusion layer and a second feature fusion layer; and fusing the image features of the i^{th} frame of image, the long time series features before the i^{th} frame of image, and the image features of the (i+1)^{th} frame of image comprises:
fusing the image features of the (i+1)^{th} frame of image and the image features of the i^{th} frame of image by using the first feature fusion layer, to obtain fused time series features; and
fusing the fused time series features and the long time series features before the i^{th} frame of image by using the second feature fusion layer, to obtain the long time series features before the (i+1)^{th} frame of image.

4. The method according to claim 3, further comprising:
obtaining a first frame of image from the video;
performing super-resolution prediction on the first frame of image using the generative network, to obtain a super-resolution image of the first frame of image and image features of the first frame of image;
obtaining a second frame of image from the video;
performing super-resolution prediction on the image features of the first frame of image and the second frame of image using the generative network, to obtain a super-resolution image of the second frame of image and image features of the second frame of image;
obtaining a third frame of image from the video;
performing super-resolution prediction on the image features of the second frame of image and the third frame of image using the generative network, to obtain a super-resolution image of the third frame of image, image features of the third frame of image, and long time series features before the third frame of image; and
caching the image features of the third frame of image and the long time series features before the third frame of image.

5. The method according to claim 1, wherein the generative network is trained by performing:
caching an i^{th} frame of sample image and an (i+1)^{th} frame of sample image from a sample video, i being a positive integer greater than 2;
predicting a super-resolution image of the i^{th} frame of sample image and a super-resolution image of the (i+1)^{th} frame of sample image using the generative network;
calculating an inter-frame stability loss between a first change and a second change using an inter-frame stability loss function, the first change being a change between the i^{th} frame of sample image and the (i+1)^{th} frame of sample image, the second change being a change between the super-resolution image of the i^{th} frame of sample image and the super-resolution image of the (i+1)^{th} frame of sample image, and the inter-frame stability loss being configured for constraining super-resolution stability between adjacent frames of images; and
training the generative network based on the inter-frame stability loss.

6. The method according to claim 5, wherein calculating the inter-frame stability loss between the first change and the second change comprises:
calculating a first optical flow of the first change using an optical flow network;
calculating a second optical flow of the second change using the optical flow network; and
substituting the first optical flow and the second optical flow into the inter-frame stability loss function, to calculate the inter-frame stability loss.

7. The method according to claim 5, further comprising:
discriminating between the super-resolution images of the (i+1)^{th} frame of sample image and the (i+1)^{th} frame of sample image using a discriminative network, to obtain a discrimination result;
calculating a first error loss of the discrimination result based on the discrimination result and an adversarial loss function; and
training the generative network and the discriminative network alternately based on the first error loss;
the adversarial loss function being configured for constraining consistency between the super-resolution result of the (i+1)^{th} frame of sample image and the discrimination result.

8. The method according to claim 7, further comprising:
calculating a second error loss between features of the (i+1)^{th} frame of sample image and features of the super-resolution image of the (i+1)^{th} frame of sample image using a perceptual loss function; and
training the generative network based on the second error loss;
the perceptual loss function being configured for constraining consistency between the (i+1)^{th} frame of sample image and the super-resolution image of the (i+1)^{th} frame of sample image in terms of eigenspace.

9. The method according to claim 8, further comprising:
calculating a third error loss between the super-resolution image of the (i+1)^{th} frame of sample image and the (i+1)^{th} frame of sample image using a pixel loss function; and
training the generative network based on the third error loss;
the pixel loss function being configured for constraining consistency between the super-resolution image of the (i+1)^{th} frame of sample image and the (i+1)^{th} frame of sample image in terms of image content.

10. A computer device, comprising one or more processors and a memory storing at least one instruction, at least one program, a code set, or an instruction set, that when the at least one instruction, the at least one program, the code set, or the instruction set being executed, cause the one or more processors to perform:
obtaining an (i+1)^{th} frame of image from a video, and obtaining image features of an i^{th} frame of image in the video and long time series features before the i^{th} frame of image, the image features of the i^{th} frame of image and the long time series features before the i^{th} frame of image being cached during super-resolution processing of the i^{th} frame of image;
performing super-resolution prediction on the image features of the i^{th} frame of image, the long time series features before the i^{th} frame of image, and the (i+1)^{th} frame of image using a generative network, to obtain a super-resolution image of the (i+1)^{th} frame of image, image features of the (i+1)^{th} frame of image, and long time series features before the (i+1)^{th} frame of image; and
caching the image features of the (i+1)^{th} frame of image and the long time series features before the (i+1)^{th} frame of image;
i being a positive integer greater than 2.

11. The device according to claim 10, wherein the generative network comprises a feature extraction network, a feature fusion network, and an upsampling network; and the one or more processors are further configured to perform:
performing feature extraction on the (i+1)^{th} frame of image using the feature extraction network, to obtain the image features of the (i+1)^{th} frame of image;
fusing the image features of the i^{th} frame of image, the long time series features before the i^{th} frame of image, and the image features of the (i+1)^{th} frame of image using the feature fusion network, to obtain the long time series features before the (i+1)^{th} frame of image; and
performing prediction on the image features of the (i+1)^{th} frame of image and the long time series features before the (i+1)^{th} frame of image by using the upsampling network, to obtain the super-resolution image of the (i+1)^{th} frame of image.

12. The device according to claim 11, wherein the feature fusion network comprises a first feature fusion layer and a second feature fusion layer; and the one or more processors are further configured to perform:
fusing the image features of the (i+1)^{th} frame of image and the image features of the i^{th} frame of image by using the first feature fusion layer, to obtain fused time series features; and
fusing the fused time series features and the long time series features before the i^{th} frame of image by using the second feature fusion layer, to obtain the long time series features before the (i+1)^{th} frame of image.

13. The device according to claim 12, wherein the one or more processors are further configured to perform:
obtaining a first frame of image from the video;
performing super-resolution prediction on the first frame of image using the generative network, to obtain a super-resolution image of the first frame of image and image features of the first frame of image;
obtaining a second frame of image from the video;
performing super-resolution prediction on the image features of the first frame of image and the second frame of image using the generative network, to obtain a super-resolution image of the second frame of image and image features of the second frame of image;
obtaining a third frame of image from the video;
performing super-resolution prediction on the image features of the second frame of image and the third frame of image using the generative network, to obtain a super-resolution image of the third frame of image, image features of the third frame of image, and long time series features before the third frame of image; and
caching the image features of the third frame of image and the long time series features before the third frame of image.

14. The device according to claim 10, wherein the one or more processors are further configured to train the generative network by performing:
caching an i^{th} frame of sample image and an (i+1)^{th} frame of sample image from a sample video, i being a positive integer greater than 2;
predicting a super-resolution image of the i^{th} frame of sample image and a super-resolution image of the (i+1)^{th} frame of sample image using the generative network;
calculating an inter-frame stability loss between a first change and a second change using an inter-frame stability loss function, the first change being a change between the i^{th} frame of sample image and the (i+1)^{th} frame of sample image, the second change being a change between the super-resolution image of the i^{th} frame of sample image and the super-resolution image of the (i+1)^{th} frame of sample image, and the inter-frame stability loss being configured for constraining super-resolution stability between adjacent frames of images; and
training the generative network based on the inter-frame stability loss.

15. The device according to claim 14, wherein the one or more processors are further configured to perform:
calculating a first optical flow of the first change using an optical flow network;
calculating a second optical flow of the second change using the optical flow network; and
substituting the first optical flow and the second optical flow into the inter-frame stability loss function, to calculate the inter-frame stability loss.

16. The device according to claim 14, wherein the one or more processors are further configured to perform:
discriminating between the super-resolution images of the (i+1)^{th} frame of sample image and the (i+1)^{th} frame of sample image using a discriminative network, to obtain a discrimination result;
calculating a first error loss of the discrimination result based on the discrimination result and an adversarial loss function; and
training the generative network and the discriminative network alternately based on the first error loss;
the adversarial loss function being configured for constraining consistency between the super-resolution result of the (i+1)^{th} frame of sample image and the discrimination result.

17. The device according to claim 16, wherein the one or more processors are further configured to perform:
calculating a second error loss between features of the (i+1)^{th} frame of sample image and features of the super-resolution image of the (i+1)^{th} frame of sample image using a perceptual loss function; and
training the generative network based on the second error loss;
the perceptual loss function being configured for constraining consistency between the (i+1)^{th} frame of sample image and the super-resolution image of the (i+1)^{th} frame of sample image in terms of eigenspace.

18. The device according to claim 17, wherein the one or more processors are further configured to perform:
calculating a third error loss between the super-resolution image of the (i+1)^{th} frame of sample image and the (i+1)^{th} frame of sample image using a pixel loss function; and
training the generative network based on the third error loss;
the pixel loss function being configured for constraining consistency between the super-resolution image of the (i+1)^{th} frame of sample image and the (i+1)^{th} frame of sample image in terms of image content.

19. A non-transitory computer-readable storage medium containing at least one program that, when being executed, causes at least one processor to perform:
obtaining an (i+1)^{th} frame of image from a video, and obtaining image features of an i^{th} frame of image in the video and long time series features before the i^{th} frame of image, the image features of the i^{th} frame of image and the long time series features before the i^{th} frame of image being cached during super-resolution processing of the i^{th} frame of image;
performing super-resolution prediction on the image features of the i^{th} frame of image, the long time series features before the i^{th} frame of image, and the (i+1)^{th} frame of image using a generative network, to obtain a super-resolution image of the (i+1)^{th} frame of image, image features of the (i+1)^{th} frame of image, and long time series features before the (i+1)^{th} frame of image; and
caching the image features of the (i+1)^{th} frame of image and the long time series features before the (i+1)^{th} frame of image;
i being a positive integer greater than 2.

20. The storage medium according to claim 19, wherein the generative network comprises a feature extraction network, a feature fusion network, and an upsampling network; and the at least one processor is further configured to perform:
performing feature extraction on the (i+1)^{th} frame of image using the feature extraction network, to obtain the image features of the (i+1)^{th} frame of image;
fusing the image features of the i^{th} frame of image, the long time series features before the i^{th} frame of image, and the image features of the (i+1)^{th} frame of image using the feature fusion network, to obtain the long time series features before the (i+1)^{th} frame of image; and
performing prediction on the image features of the (i+1)^{th} frame of image and the long time series features before the (i+1)^{th} frame of image by using the upsampling network, to obtain the super-resolution image of the (i+1)^{th} frame of image.
